(19) United States
(12) Patent Application Publication
(10) Pub. No.: US 2009/0049745 A1
(43) Pub. Date: Feb. 26, 2009

(54) Automatic indoor-plant watering device where water delivery (frequency & amount) is controlled by a battery operated water-timer from the independent water reservoir

(76) Inventor: Syed Mazhar Ali, Yakima, WA (US)

Correspondence Address: SYED M. ALI, 107 N. 91st. Avenue, YAKIMA, WA, 98908, US

(21) Appl. No.: 12/149,298

(22) Filed: Apr. 30, 2008

Related U.S. Application Data
(60) Provisional application No. 60/927,757, filed on May 4, 2007.

(51) Int. Cl. A01G 27/00

(52) U.S. Cl. 47/48.5

(57) ABSTRACT

The novel idea of using battery operated water-timer in this invention which is attached at the outlet of the up-side down water bottle (water-reservoir) and regulates the flow of water in a predictable manner. This water reservoir is independent, has no connection with the tap water, needs to be filled manually with water as per the need.

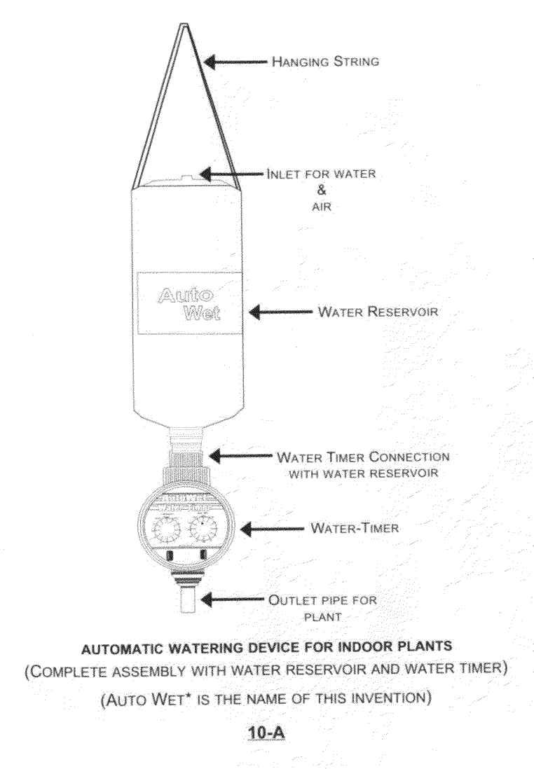

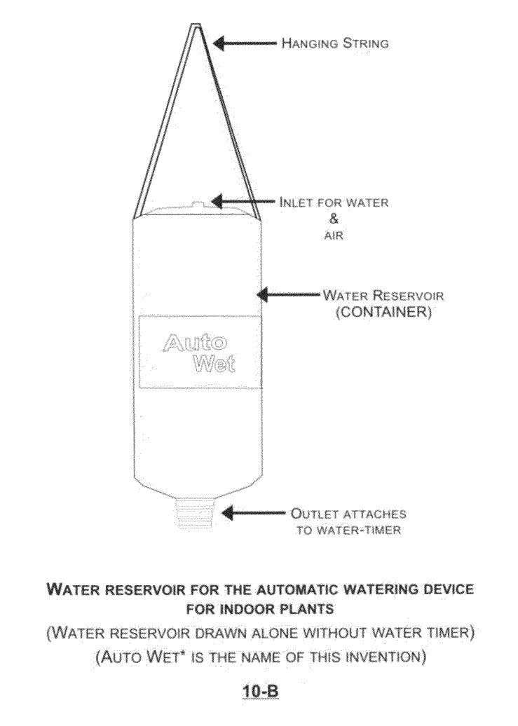

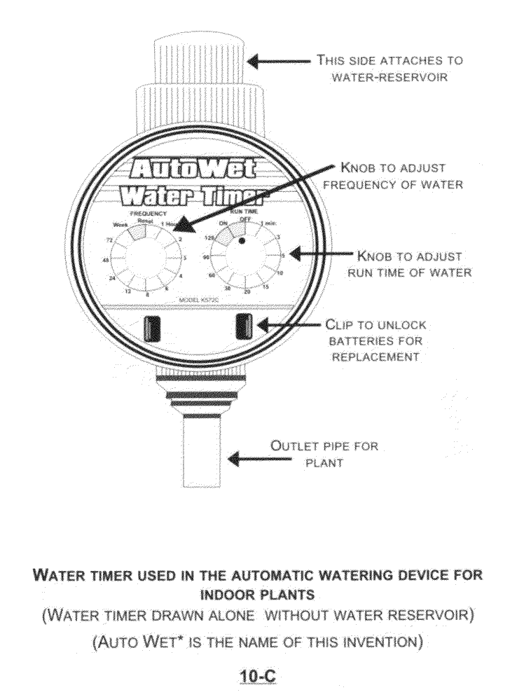

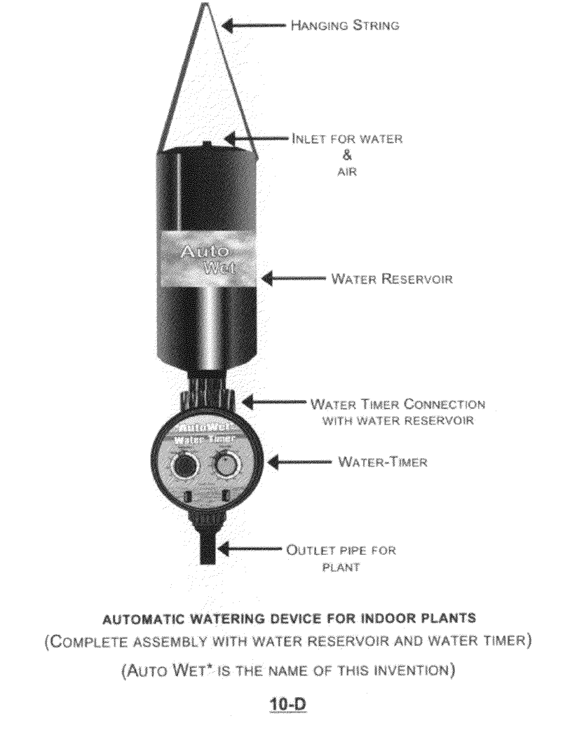

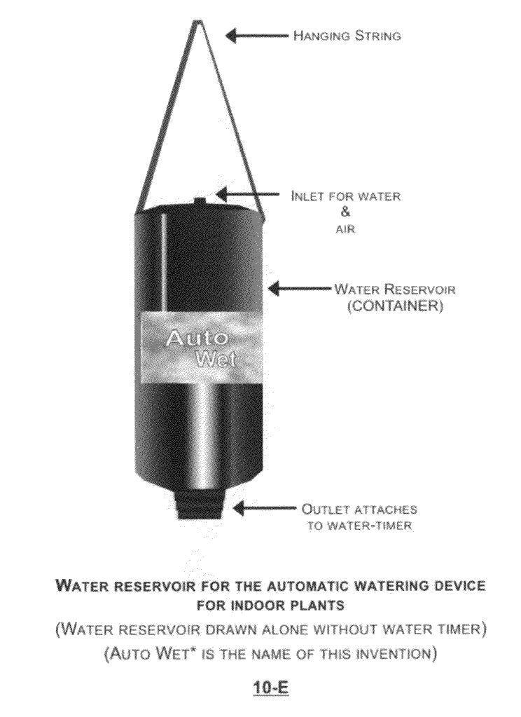

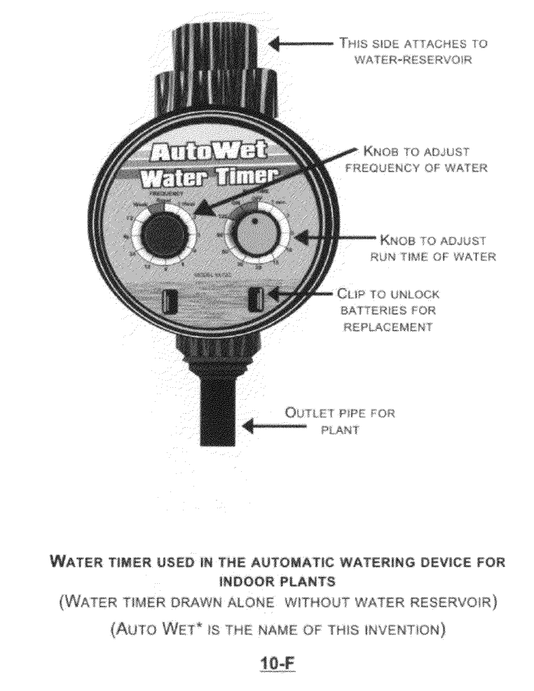

As a normal course, the flow of water from an up-side down bottle will freely run down due to gravity but when the water-timer is attached at the outlet of the bottle, the flow of water is regulated.

As a result, the desired amount of the water may be supplied to the plant at a desired interval by adjusting the frequency and run-time in the water timer.

### CROSS-REFERENCE TO RELATED APPLICATION

Provisional Patent Application No. 60/927,757

Filing date: May 4, 2007

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT APPENDIX

Not Applicable

### BACKGROUND OF THE INVENTION

This invention is a device for the watering of the indoor plants.

The watering (irrigation) of indoor plants is still a considerable challenge for those who are going on vacation or leaving their homes for 2 to 3 weeks.

There are a few options available in the market which include the water holding tray at the bottom of the flowering pot, moisturizing gel, water irrigation through capillary action, wick system, dripper, or the use of a water filled plastic bottle for dripping water in the plant.

All these systems are providing some water supply to the plant but in a very unpredictable manner. As a result, the plant is receiving the water supply either too much in a short period of time, too less or sometimes nothing due to functional failure.

Keeping in view the above imperfect choices, people prefer to give keys to the neighbor, friend, family member or to the house keeper to take care of their indoor plants while they are gone on vacation. Although this is a commonly practiced option in the country and considered the most dependable, it is not very feasible for some people because of security issues.

### BRIEF SUMMARY OF THE INVENTION

It was a big challenge in the summer of 2005 to leave our indoor plants without water for 2 weeks while we were gone on vacation. All the options available in the market for watering the indoor plants were either imperfect or not very dependable.

Our invention which is a perfect system for watering the indoor plants especially for vacation goers, consist of mainly two parts, the water reservoir of a suitable size and a water timer. The water-timer is tightly attached through a threaded assembly at the outlet of the water reservoir. The device works in an up-side down position in a way that the bottom of the reservoir is up and water-timer side and the outlet pipe down, directed towards the plant.

The bottom of the water reservoir has the openings for the air and water inlet. The amount of water can be regulated easily by setting the frequency and the run-time on the water timer.

Our invention has solved the previously existing problems in the inventions or options available in the market for watering the indoor plants by providing the desired amount of water to the plant at a desired interval for a desired length of time just by setting the frequency and run-time on the water timer.

The problems encountered in the previously existing systems in the market as defined above in “Background of the invention” or giving the house key to the neighbor, family member or friend has been solved with our invention for watering the indoor plants.

The working model of our invention is successfully working in our home.

### BRIEF DESCRIPTION OF THE SEVERAL VIEWS OF THE DRAWING

There are 6 sheets of the drawings/photos attached at page number # 10-A, 10-B, 10-C, 10-D, 10-E, 10-F

Page # 10-A

This is the drawing of the complete assembly of the invention displaying the water reservoir attached with the water-timer and hanged with the string.

Page # 10-B

This is the drawing of the water reservoir alone, shown with hanging string

Page# 10-C

This is the drawing of the Water-timer used in this invention. Water timer is a common technology available in the market from many companies, used to regulate the flow of water.

Page# 10-D

This is the photograph of the working model of the invention, which shows the water reservoir is attached with the water timer and the whole unit is hanged with the string.

Page # 10-E

This is the photograph of the water reservoir alone used in the invention

Page# 10-F

This is the photograph of the Water timer alone used in the invention

### DETAILED DESCRIPTION OF THE INVENTION

Our invention, a portable device for the watering of the indoor plants, constitutes of mainly two parts, the water reservoir and the water timer*. * Water timer which is used in this invention, is a common technology available in the market to regulate the frequency and run-time of the water. It requires two AAA batteries to run and the small blinking light in the middle indicates that batteries are alive. If that light is not blinking then batteries need to be changed (see page # 10-C & 10-F).

The water reservoir, preferably made-up of plastic in a suitable shape, preferably cylindrical or bottle shaped and big enough to hold at least 1 to 2 litters of water or may be more as feasible (see page. # 10-B & 10-E).

This water reservoir is independent, has no connection to the tap water and the water is filled manually in the reservoir as per the need.

A water timer is attached tightly through a threaded assembly at the opening of the water reservoir. The whole device functions in an up-side down position, so that the bottom portion of the water reservoir is up and its opening side which is attached with the water timer is down towards the plant. The bottom of the water reservoir which remains up while the device is in function, has openings for the air and water inlet. The outlet of the water timer is attached with the dripping pipe of a suitable length and directed towards the plant which needs the water. (see page # 10-A & 10-D)

The water-timer has two adjustable knobs, the “Frequency” and “Run-Time” which allows to control the amount and frequency of the water supply to the plant (see page # 10-C & 10-F).

The option of “frequency” on the water timer helps to adjust that how frequently plant needs water. It may be set either 1, 2, 3, 4, 5, 6, 8, 12, 24, 48 or 72 hours or may be every week, depending on the individual plant's requirement. The “run time” option on the water timer allows to regulate the amount of water by adjusting the timing from 1 minute to 120 minutes depends how long or how much plant needs the water.

For example, if the size of the water reservoir is 2 litters, the width of dripping pipe is ⅛^{th} inch, and frequency of the water timer is set for 48 hours with the run time of 1 min., then the device may deliver approximately 8 ounces of water every other day for at least two weeks. The amount of water needed for the plant and its frequency may be changed by adjusting the “frequency” and “run-time” on the water-timer.

This invention provides a set amount of water to the plant without any failure at a desired frequency where as no other invention in the market has this convenience of option for the indoor plants.

The use of water-timer in the up-side down water bottle (water reservoir) is the key improvement introduced in this device.

There are water bottles available in the market for indoor plants watering but the flow of water from these water bottles is unregulated or unpredictable. Some times they release excessive amount of water in a short period of time and sometimes the opening is clogged and does not function at all. Our invention has overcome these problems just by using the water timer at the outlet of the water bottle (water reservoir).

1. What we claim as our invention is for the purpose of watering indoor plants which provides the desired amount of water to the plant at a desired interval in a predictable manner by means of using the water-timer to regulate the flow of water from an up-side down independent water reservoir.
